(19) United States
(12) Patent Application Publication
(10) Pub. No.: US 2019/0322836 A1
(43) Pub. Date: Oct. 24, 2019

(54) POLYMER COMPOSITIONS

(71) Applicant: IMERTECH SAS, Paris (FR)

(72) Inventors: Meli GILLES, Le Fauga (FR); Daniele BONACCHI, Bodio (CH)

(21) Appl. No.: 16/469,921

(22) PCT Filed: Nov. 28, 2017
(86) PCT No.: PCT/EP2017/080727

§ 371 Date: Jun. 14, 2019

(30) Foreign Application Priority Data
Dec. 15, 2016 (EP) 16306685.5

(51) Int. Cl. C08K 3/04; C09K 5/14; C08F 210/06; C08K 3/34; C08J 3/20

(52) U.S. Cl. CPC C08K 3/04; C09K 5/14; C08F 210/06; C08K 3/34; B29B 11/10; C08K 2003/343; C08K 2201/001; C08K 2201/005; C08J 3/203

(57) ABSTRACT

A composition comprising a polymer and a graphitic material, a process for making said composition and use of said composition to make a composite or article, for example an automotive body part.

### TECHNICAL FIELD

The present invention relates generally to the use of a graphitic material in a polymer composition in order to provide the composition with improved scratch resistance, colour, thermal conductivity, electrical conductivity, UV stability and other properties while maintaining tensile strength and stiffness. The present invention further relates to polymer composites and articles (e.g. resin compound when compression molded) formed from said polymer composition, and methods for making said polymer compositions, composites and articles.

### BACKGROUND

Inorganic particulate materials are generally used as fillers in polymer compositions, for example to reduce the amount of polymer in the composition, for example to reduce the cost of the composition. The inorganic particulate material may also affect the properties of the polymer composition. For example, the use of inorganic particulate materials in polymer compositions may influence the colour, strength, stiffness, impact resistance and/or flexibility of the polymer composition. The nature of the inorganic particulate material may also influence the processing of the polymer composition.

In particular, talc particulates have been developed to provide stiffness in plastics. Today, talc is mainly used in polypropylene based compositions with a talc content ranging from about 5 wt % to about 40 wt %, based on the total weight of the composition. These compositions are commonly used to make lightweight automotive parts. Carbon black may be used to make the composition appear to be black. However, a white colour may be revealed if the composition is scratched.

It is therefore desirable to provide alternative and/or improved inorganic particulate materials suitable for use in reinforcing polymer compositions.

### SUMMARY

The present invention aims, at least in part, to provide compositions comprising polymer and graphitic material, for example having good mechanical characteristics and/or a desirable black colour, even when scratched and/or marred.

In accordance with a first aspect, there is provided a composition comprising a polymer and equal to or greater than about 1 wt % of a graphitic material. In certain embodiments, the composition has a L* value equal to or less than about 65. Thus, in accordance with a further aspect of the present invention, there is provided a composition comprising a polymer and equal to or greater than about 1 wt % of a graphic material, wherein the composition has a L* value equal to or less than about 65.

In accordance with a second aspect, there is provided a polymer composite or polymer article formed from a composition in accordance with any aspect or embodiment of the present invention. In certain embodiments, the polymer composite or polymer article is formed by extrusion and/or molding.

In accordance with a third aspect, there is provided a method of making a composition in accordance with any aspect or embodiment of the present invention, the method comprising combining the polymer, the graphitic material and any optional components.

In accordance with a fourth aspect, there is provided a method of making a polymer composite or polymer article in accordance with any aspect or embodiment of the present invention, the method comprising extruding and/or molding a composition in accordance with any aspect or embodiment of the present invention.

In accordance with a fifth aspect, there is provided a use of a composition, polymer composite and/or polymer article in accordance with any aspect or embodiment of the present invention to make an automotive body part.

In accordance with a sixth aspect, there is provided the use of a graphitic material to replace at least some (e.g. all) of a talc particulate in a polymer composition. The mechanical properties (e.g. stiffness and/or impact resistance) of the polymer composition comprising the graphitic material may be comparable to (e.g. be within 10% of) the mechanical properties of the polymer composition not comprising the graphitic material (e.g. comprising talc as the only inorganic particulate material). The polymer composition comprising the graphitic material may, for example, have a lower L* value after scratching than the polymer composition not comprising the graphitic material.

In accordance with a seventh aspect, there is provided the use of at least about 1 wt % of a graphitic material as a filler in a polymer composition (based on the total weight of the composition) to replace at least a portion of another inorganic mineral filler and/or to provide at least one of the following properties as compared to the polymer composition that is devoid of the at least about 1 wt % of the graphitic material:
a. higher impact resistance;
b. higher tensile strength
c. higher stiffness;
d. lower L* value (e.g. after scratching);
e. higher thermal conductivity;
f. reduced cycling time during processing;
g. higher electrical conductivity;
h. increased UV stability
i. decreased weight; and
j. decreased density.

Certain embodiments or aspects of the present invention may provide one or more of the following advantages:
good mechanical properties (e.g. strength, impact resistance, stiffness), for example mechanical properties comparable to those of compositions comprising an alternative inorganic particulate material filler;
good black colour after scratching (e.g. darker or lower L* value after scratching in comparison to compositions comprising an alternative inorganic particulate material filler);
thermal conductivity which may, for example, lead to reduced cycling time during processing;
electrical conductivity which may, for example, enable the composition to be suitable for electrostatic painting or plating systems;
decreased weight and/or density.

The details, examples and preferences provided in relation to any particular one or more of the stated aspects of the present invention apply equally to all aspects of the present invention. Any combination of the embodiments, examples and preferences described herein in all possible variations thereof is encompassed by the present invention unless otherwise indicated herein, or otherwise clearly contradicted by context.

### DETAILED DESCRIPTION

The present invention is based, at least in part, on the surprising finding that a graphitic material can provide reinforcement to a polymer composition, for example comparable reinforcement to inorganic particulate materials (e.g. talc) that are currently used to reinforce polymer compositions. The present invention is further based, at least in part, on the surprising finding that polymer compositions comprising a graphitic material are black in colour and can retain their black colour after scratching and/or marring. The present invention is further based, at least in part, on the surprising finding that polymer compositions comprising a graphitic material may be thermally conductive, electrically conductive, stable to UV, and are lightweight, for example whilst maintaining the reinforcing/mechanical properties of the composition.

Polymer Compositions, Composites and Articles

The present invention thus provides a composition comprising a polymer and a graphitic material.

The term “graphitic material” refers to materials that comprise a crystalline form of carbon that has a layered structure (individual layers known as graphene), where the layers are held together by Van der Waals bonds. The graphitic material may, for example, be natural graphite, synthetic graphite, expanded graphite, exfoliated graphite, graphene, few-layer graphene (comprising two to ten atomic layers), graphite fibers, nano-graphite, graphitized coke (e.g. graphitized fine coke), or mixtures thereof. Hereinafter, the present invention may be referred to in terms of natural graphite or synthetic graphite. However, the invention should not be construed as being limited to such embodiments.

When the graphitic material is obtained from naturally occurring sources, it may be that some mineral impurities will inevitably contaminate the ground material. In general, however, the graphitic material used in the invention will contain less than 5% by weight, preferably less than 1% by weight of other mineral impurities.

The graphitic material may, for example, have a d₅₀ ranging from about 1 μm to about 20 μm. For example, the graphitic material may have a d₅₀ ranging from about 1.5 μm to about 20 μm or from about 2 μm to about 20 μm or from about 2.5 μm to about 20 μm or from about 3 μm to about 20 μm or from about 3.5 μm to about 20 μm or from about 4 μm to about 20 μm or from about 4.5 μm to about 19.5 μm or from about 5 μm to about 19 μm or from about 5.5 μm to about 18.5 μm or from about 6 μm to about 18 μm or from about 6.5 μm to about 17.5 μm or from about 7 μm to about 17 μm or from about 7.5 μm to about 16.5 μm or from about 8 μm to about 16 μm or from about 8.5 μm to about 15.5 μm or from about 9 μm to about 15 μm or from about 9.5 μm to about 14.5 μm or from about 10 μm to about 14 μm. For example, the graphitic material may have a d₅₀ ranging from about 1 μm to about 8 μm or from about 1 μm to about 7 μm or from about 1 μm to about 6 μm or from about 1 μm to about 5 μm. For example, the graphitic material may have a d₅₀ ranging from about 12 μm to about 20 μm or from about 14 μm to about 20 μm or from about 15 μm to about 19 μm. For example, the graphitic material may be a natural graphite and have a d₅₀ ranging from about 5 μm to about 18 μm. For example, the graphitic material may be a synthetic graphite and have a d₅₀ ranging from about 15 μm to about 20 μm.

The graphitic material may, for example, have a d₉₀ ranging from about 2 μm to about 50 μm. For example, the graphitic material may have a d₉₀ ranging from about 4 μm to about 50 μm or from about 6 μm to about 50 μm or from about 8 μm to about 50 μm or from about 10 μm to about 48 μm or from about 12 μm to about 46 μm or from about 14 μm to about 44 μm or from about 16 μm to about 42 μm or from about 18 μm to about 40 μm or from about 20 μm to about 38 μm or from about 22 μm to about 36 μm or from about 24 μm to about 34 μm or from about 26 μm to about 32 μm or from about 28 μm to about 30 μm. For example, the graphitic material may have a d₉₀ ranging from about 30 μm to about 50 μm or from about 35 μm to about 45 μm or from about 36 μm to about 44 μm or from about 38 μm to about 42 μm. For example, the graphitic material may be a natural graphite and have a d₉₀ ranging from about 10 μm to about 50 μm or from about 10 μm to about 45 μm or from about 20 μm to about 40 μm or from about 30 μm to about 40 μm. For example, the graphitic material may be a synthetic graphite and have a d₉₀ ranging from about 35 μm to about 45 μm or from about 40 μm to about 45 μm.

The graphitic material may, for example, have a d₅₀ ranging from about 5 μm to about 18 μm and a d₉₀ ranging from about 10 μm to about 40 μm. The graphitic material may, for example, have a d₅₀ ranging from about 4 μm to about 8 μm and a d₉₀ ranging from about 10 μm to about 14 μm. The graphitic material may, for example, have a d₅₀ ranging from about 15 μm to about 20 μm and a d₉₀ ranging from about 36 μm to about 42 μm. The graphitic material may, for example, have a d₅₀ ranging from about 16 μm to about 20 μm and a d₉₀ ranging from about 40 μm to about 44 μm.

The graphitic material may, for example, have a BET specific surface area ranging from about 4 to about 100 m²/g. For example, the graphitic material may have a BET specific surface area ranging from about 4 to about 90 m²/g or from about 4 to about 80 m²/g or from about 4 to about 70 m²/g or from about 4 to about 60 m²/g or from about 4 to about 50 m²/g or from about 4 to about 40 m²/g or from about 4 to about 30 m²/g or from about 4 to about 20 m²/g or from about 4 to about 18 m²/g or from about 4 to about 16 m²/g or from about 4 to about 15 m²/g or from about 4 to about 14 m²/g or from about 4 to about 12 m²/g or from about 4 to about 11 m²/g. For example, the graphitic material may have a BET specific surface area ranging from about 4 to about 11 m²/g or from about 4.5 to about 11 m²/g or from about 4.8 to about 10.8 m²/g.

Unless otherwise stated, particle size measurements are determined using the Malvern laser light scattering technique. In this technique, the size of particles in powders, suspensions and emulsions may be measured using the diffraction of a laser beam, based on an application of Mie theory. Such a machine, for example a Malvern Mastersizer S (as supplied by Malvern Instruments) provides measurements and a plot of the cumulative percentage by volume of particles having a size, referred to in the art as the ‘equivalent spherical diameter’ (e.s.d), less than given e.s.d values. The d₅₀ and d₉₀ are the values determined in this way of the particle e.s.d at which there are 50% and 90% respectively by volume of the particles which have an equivalent spherical diameter less than that d₅₀ or d₉₀ value respectively.

As used herein, “specific surface area (BET)” means the area of the surface of the particles of the mineral with respect to unit mass, determined according to the BET method by the quantity of nitrogen adsorbed on the surface of said particles so to as to form a monomolecular layer completely covering said surface (measurement according to the BET method, AFNOR standard X11-621 and 622 or ISO 9277). In certain embodiments, specific surface is determined in accordance with ISO 9277, or any method equivalent thereto.

The composition may, for example, comprise equal to or greater than about 1 wt % of graphitic material, based on the total weight of the composition. For example, the composition may comprise equal to or greater than about 2 wt % or equal to or greater than about 3 wt % or equal to or greater than about 4 wt % or equal to or greater than about 5 wt % or equal to or greater than about 6 wt % or equal to or greater than about 7 wt % or equal to or greater than about 8 wt % or equal to or greater than about 9 wt % or equal to or greater than about 10 wt % of graphitic material based on the total weight of the composition.

The composition may, for example, comprise up to about 70 wt % of graphitic material, based on the total weight of the composition. For example, the composition may comprise up to about 60 wt % or up to about 55 wt % or up to about 50 wt % or up to about 45 wt % or up to about 40 wt % or up to about 35 wt % or up to about 30 wt % or up to about 25 wt % or up to about 20 wt % of graphitic material.

The composition may, for example, comprise from about 1 wt % to about 70 wt % or from about 5 wt % to about 70 wt % or from about 10 wt % to about 70 wt % of graphitic material. The composition may, for example, comprise from about 1 wt % to about 50 wt % or from about 5 wt % to about 50 wt % or from about 10 wt % to about 50 wt % of graphitic material. The composition may, for example, comprise from about 1 wt % to about 40 wt % or from about 5 wt % to about 40 wt % or from about 10 wt % to about 40 wt % of graphitic material. The composition may, for example, comprise from about 1 wt % to about 30 wt % or from about 5 wt % to about 30 wt % or from about 10 wt % to about 30 wt % of graphitic material. The composition may, for example, comprise from about 1 wt % to about 20 wt % or from about 5 wt % to about 20 wt % or from about 10 wt % to about 20 wt % of graphitic material.

The polymer may be any natural or synthetic polymer or mixture thereof. The polymer may, for example, be thermoplastic or thermoset. The term “polymer” used herein includes homopolymers and/or copolymers, as well as crosslinked and/or entangled polymers.

The term “precursor” as may be applied to the polymer component will be readily understood by one of ordinary skill in the art. For example, suitable precursors may include one or more of: monomers, cross-linking agents, curing systems comprising cross-linking agents and promoters, or any combination thereof. Where, according to the present invention, the graphitic material is mixed with precursors of the polymer, the polymer composition will subsequently be formed by curing and/or polymerising the precursor components to form the desired polymer.

Polymers, including homopolymers and/or copolymers, comprised in the composition of the present invention may be prepared from one or more of the following monomers: acrylic acid, methacrylic acid, methyl methacrylate, and alkyl acrylates having 1-18 carbon atoms in the alkyl group, styrene, substituted styrenes, divinyl benzene, diallyl phthalate, butadiene, vinyl acetate, acrylonitrile, methacrylonitrile, maleic anhydride, esters of maleic acid or fumaric acid, tetrahydrophthalic acid or anhydride, itaconic acid or anhydride, and esters of itaconic acid, with or without a cross-linking dimer, trimer, or tetramer, crotonic acid, neopentyl glycol, propylene glycol, butanediols, ethylene glycol, diethylene glycol, dipropylene glycol, glycerol, cyclohexanedimethanol, 1,6 hexanediol, trimethyolpropane, pentaerythritol, phthalic anhydride, isophthalic acid, terephthalic acid, hexahydrophthalic anyhydride, adipic acid or succinic acids, azelaic acid and dimer fatty acids, toluene diisocyanate and diphenyl methane diisocyanate.

The polymer may be selected from one or more of polymethylmethacrylate (PMMA), polyacetal, polycarbonate, polyvinyls, polyacrylonitrile, polybutadiene, polystyrene, polyacrylate, polyolefins (polyalkenes), polyethylene, polypropylene, epoxy polymers, unsaturated polyesters, polyurethanes, polycyclopentadienes and copolymers thereof. Suitable polymers also include liquid rubbers, such as silicones.

The polymers which may be used in accordance with the invention are advantageously thermoplastic polymers. Thermoplastic polymers are those which soften under the action of heat and harden again to their original characteristics on cooling, that is, the heating-cooling cycle is fully reversible. By conventional definition, thermoplastics are straight and branched linear chain organic polymers with a molecular bond. Examples of polymers which may be used in accordance with the invention include, but are not limited to polyethylene, for example, linear low density polyethylene (LLDPE) and medium density grades thereof, high density polyethylene (HDPE), low density polyethylene (LDPE), polypropylene (PP), polyethylene terephthalate (PET), vinyl/polyvinyl chloride (PVC), polystyrene, and mixtures thereof.

In certain embodiments, the polymer is a polyalkylene polymer, for example, polyethylene, polypropylene, polybutylene, or a copolymer of two or more of ethylene, propylene and butylenes monomers, for example, an ethylene-propylene copolymer. In certain embodiments, the polymer is a mixture of two or more of propylene, polyethylene and ethylene-propylene copolymer, for example a mixture of propylene and polyethylene. In certain embodiments, the polymer is polypropylene. In certain embodiments, the polymer comprises, consists essentially of, or consists of polypropylene or polyethylene or a mixture of polypropylene and polyethylene.

The composition may, for example, comprise at least about 20 wt % of the polymer, based on the total weight of the composition. For example, the composition may comprise at least about 25 wt % or at least about 30 wt % or at least about 35 wt % or at least about 40 wt % or at least about 45 wt % or at least about 50 wt % of the polymer. The composition may, for example, comprise up to about 99.5 wt % of the polymer. For example, the composition may comprise up to about 95 wt % or up to about 90 wt % or up to about 85 wt % or up to about 80 wt % or up to about 75 wt % or up to about 70 wt % of the polymer.

The composition may, for example, comprise an inorganic particulate material other than the graphitic material, including, but not limited to, talc, carbon black, an alkaline earth metal carbonate or sulphate, such as calcium carbonate, magnesium carbonate, dolomite, gypsum, a hydrous kandite clay such as kaolin, halloysite or ball clay, an anhydrous (calcined) kandite clay such as metakaolin or fully calcined kaolin, mica, perlite, feldspars, nepheline syenite, wollastonite, diatomaceous earth, barite, glass, and natural or synthetic silica or silicates. In certain embodiments, the composition further comprises talc. In certain embodiments, the composition further comprises carbon black. In certain embodiments, the composition further comprises talc and carbon black.

The additional inorganic particulate materials may be included during preparation of the composition, or alternatively, during preparation of the graphitic material, e.g., graphitic material may be mixed and blended with the other inorganic particulate material, optionally combined with surface treatment agent. In such embodiments, the other inorganic particulate materials may be surface treated with the surface treatment agent.

The amount of the other inorganic particulate material may, for example, range from about 5 wt % to about 70 wt %, for example from about 10 wt % to about 60 wt % or from about 15 wt % to about 50 wt % or from about 20 wt % to about 40 wt %. For example, the amount of the other inorganic particulate material may range from about 5 wt % to about 40 wt % or from about 10 wt % to about 35 wt % or from about 15 wt % to about 30 wt % or from about 20 wt % to about 25 wt %.

In certain embodiments, the composition further comprises from about 5 wt % to about 70 wt % of talc. For example, the composition may further comprise from about 10 wt % to about 60 wt % or from about 20 wt % to about 50 wt % or from about 30 wt % to about 40 wt % of talc. For example, the composition may further comprise from about 5 wt % to about 40 wt % of talc, for example from about 5 wt % to about 30 wt % or from about 5 wt % to about 20 wt % or from about 10 wt % to about 35 wt % or from about 10 wt % to about 30 wt % or from about 15 wt % to about 30 wt % or from about 20 wt % to about 25 wt % of talc.

The talc may, for example, be surface-treated. As used herein, the term “surface treated” means particles of the talc are contacted with a compound which adheres (e.g., physisorbed or bonded) or is otherwise associated with the surface of the talc. Surface treatment of the talc may serve to reduce or eliminate aggregation of the talc particulates and/or enhance incorporation of the talc particulate into a polymer composition.

Suitable surface treatment agents include a compound with hydrophobic carbon chains bearing polar radicals, for example, the family of amines, silanes, siloxanes, alcohols or acids and metals salts thereof. For example the surface treatment agent is a polyether or a derivative thereof, for example, polyether modified polysiloxane.

The polyether may be a polyoxyalkylene (POA), for example, polyalkylene glycol (PAG) or polyalkylene oxide (PAO). As used herein, the term ‘polyalkylene glycol’ means a POA having a number average molecular mass below 20,000 g/mol, and the term ‘polyalkylene oxide’ means a POA having a number average molecular mass above 20,000 g/mol. In certain embodiments, the surface treatment agent comprises or is a polyalkylene glycol having a number average molecular mass of from about 100 to about 15,000 g/mo, for example, from about 200 to about 10,000 g/mol, or from about 500 to about 9000 g/mol, or from about 1000 to about 9000 g/mol, or from about 2000 to about 900 g/mol, or from about 4000 to about 9000 g/mol, or from about 6000 to about 9000 g/mol, or from about 6000 to about 8500 g/mol.

The polyether may be a polyalkylene oxide selected from one or more of paraformaldehyde (polymethylene oxide), polytetramethylene glycol, polytetramehtylene ether glycol, polyethylene oxide, polypropylene oxide, polybutylene oxide, and combinations thereof.

The surface treatment agent may comprise or may be polyethylene glycol. The surface treatment may comprise or may be a mixture of polyethylene glycol and polypropylene glycol (PPG). The surface treatment agent may be polyethylene glycol having a number average molecular mass of from about 200 to about 10,000 g/mol, for example, from about 500 to about 9000 g/mol, or from about 1000 to about 9000 g/mol, or from about 2000 to about 900 g/mol, or from about 4000 to about 9000 g/mol, or from about 6000 to about 9000 g/mol, or from about 6000 to about 8500 g/mol. An exemplary PEG includes the Puriol™ range of polyglycols from BASF, for example, Puriol™ 8005.

The surface treatment agent may comprise or be a fatty acid, and/or a metal salt thereof, for example, stearic acid or a metal stearate, such as magnesium, calcium or zinc stearate.

Suitable silane based agents are aminosilanes, for example, trimethoxysilyl ethyl amine, triethoxysilyl ethyl amine, tripropoxysilyl ethyl amine, tributoxysilyl ethyl amine, trimethoxysilyl propyl amine, triethoxysilyl propyl amine, tripropoxysilyl propyl amine, triisopropoxysilyl propyl amine, tributoxysilyl propyl amine, trimethoxysilyl butyl amine, triethoxysilyl butyl amine, tripropoxysilyl butyl amine, tributoxysilyl butyl amine, trimethoxysilyl pentyl amine, triethoxysilyl pentyl amine, tripropoxysilyl pentyl amine, tributoxysilyl pentyl amine, trimethoxysilyl hexyl amine, triethoxysilyl hexyl amine, tripropoxysilyl hexyl amine, tributoxysilyl hexyl amine, trimethoxysilyl heptyl amine, triethoxysilyl heptyl amine, tripropoxysilyl heptyl amine, tributoxysilyl heptyl amine, trimethoxysilyl octyl amine, triethoxysilyl octyl amine, tripropoxysilyl octyl amine, tributoxysilyl octyl amine, and the like. Suitable agents having a hydrocarbyl group and a polar group are hydrocarbyl amines such as triethanolamine (TEA), and amino alcohol agents such as 2-amino-2-methyl-1-propanol. AMP-95® is a commercially available 2-amino-2-methyl-1-propanol formulation containing 5% water.

The surface treatment agent may be added in an amount effective to achieve the desired result. In certain embodiments, the quantity of surface treatment agent is from about 0.1% to 5% by weight with respect to the weight of talc, for example, from about 0.1% to 2% by weight with respect to the weight of talc.

Surface treatment agents may be applied by adding to the talc and mixing using conventional methods. Surface treatment agents may be applied during preparation of the talc from a relatively coarse talc starting material and before the talc is added to a polymer composition.

The weight ratio of talc to graphitic material may, for example, range from about 20:1 to about 1:20. For example, the weight ratio of talc to graphitic material may range from about 15:1 to about 1:15, for example from about 10:1 to about 1:10, for example from about 5:1 to about 1:5. For example, the weight ratio of talc to graphitic material may range from about 20:1 to about 1:10 or from about 20:1 to about 1:5 or from about 20:1 to about 1:2 or from about 20:1 to about 1:1. For example, the weight ratio of talc to graphitic material may range from about 10:1 to about 1:10 or from about 10:1 to about 1:5 or from about 10:1 to about 1:2 or from about 10:1 to about 1:1. For example, the weight ratio of talc to graphitic material may range from about 5:1 to about 1:10 or from about 5:1 to about 1:5 or from about 5:1 to about 1:2 or from about 5:1 to about 1:1.

In certain embodiments, the composition further comprises from about 1 wt % to about 10 wt % carbon black. For example, the composition may further comprise from about 2 wt % to about 9 wt % or from about 3 wt % to about 8 wt % or from about 4 wt % to about 7 wt % or from about 5 wt % to about 6 wt % of carbon black.

The weight ratio of carbon black to graphitic material may, for example, range from about 5:1 to about 1:50. For example, the weight ratio of carbon black to graphitic material may range from about 2:1 to about 1:50 or from about 1:1 to about 1:50. For example, the weight ratio of carbon black to graphitic material may range from about 2:1 to about 1:40 or from about 2:1 to about 1:30 or from about 2:1 to about 1:20 or from about 2:1 to about 1:10 or from about 2:1 to about 1:5. For example, the weight ratio of carbon black to graphitic material may range from about about 1:1 to about 1:40 or from about 1:1 to about 1:30 or from about 1:1 to about 1:20 or from about 1:1 to about 1:10 or from about 1:1 to about 1:5.

In certain embodiments, the amount of other inorganic particulate materials other than graphitic material, talc and carbon black is less than about 10% by weight, based on the total weight of the polymer composition, for example, less than about 5% by weight, or less than about 1% by weight, or less than about 0.5% by weight, or less than about 0.4% by weight, or less than about 0.3% by weight, or less than about 0.2% by weight, or less than about 0.1% by weight.

In certain embodiments, the total amount of inorganic particulate material in the composition (i.e. including any graphitic material, talc and carbon black) is no more than about 80 wt %. For example, the composition may comprise up to about 75 wt % or up to about 70 wt % or up to about 65 wt % or up to about 60 wt % or up to about 55 wt % or up to about 50 wt % total inorganic particulate material.

In certain embodiments, the composition is a masterbatch composition (suitable for combination with additional polymer to form a final polymer composition). In other embodiments, the composition is a final polymer composition that may be processed to form a polymer composite or article without addition of further polymer.

The total amount of inorganic particulate material may be higher in a masterbatch composition than in the final polymer composition. If the composition is a masterbatch composition, the total amount of inorganic particulate material in the composition may range from about 40 wt % to about 80 wt %, for example from about 45 wt % to about 75 wt % or from about 50 wt % to about 75 wt % or from about 55 wt % to about 75 wt % or from about 60 wt % to about 70 wt %, based on the total weight of the composition. If the polymer composition is a masterbatch composition, the total amount of graphitic material in the composition may range from about 5 wt % to about 80 wt %, for example from about 10 wt % to about 75 wt % or from about 20 wt % to about 70 wt % or from about 25 wt % to about 65 wt % or from about 30 wt % to about 60 wt % or from about 40 wt % to about 50 wt %. If the composition is a final polymer composition, the total amount of inorganic particulate material in the composition may range from about 1 wt % to about 60 wt %, for example from about 1 wt % to about 45 wt % or from about 1 wt % to about 30 wt % or from about 1 wt % to about 20 wt % or from about 5 wt % to about 40 wt % or from about 10 wt % to about 35 wt % or from about 15 wt % to about 30 wt %. If the composition is a final polymer composition, the total amount of graphitic material in the composition may range from about 1 wt % to about 50 wt %, for example from about 1 wt % to about 45 wt % or from about 5 wt % to about 40 wt % or from about 10 wt % to about 35 wt % or from about 15 wt % to about 30 wt %.

In certain embodiments, the graphitic material may be used as a functional filler in a polymer composition, for example, to modify or enhance one or more mechanical properties of the polymer composition or to modify one or more colour characteristics of the polymer composition. In certain embodiments, the graphitic material may be used to provide the composition, composite or article with thermal conductivity and/or electrical conductivity.

In certain embodiments, the graphitic material may be used as an extended filler, for example, to supplement or supplant other filler materials, which may be more difficult to incorporate into the polymer composition.

In certain embodiments, the polymer composition, composite or article has an L* value equal to or less than about 65. For example, the polymer composition, composite or article may have an L* value equal to or less than about 60 or equal to or less than about 55 or equal to or less than about 50 or equal to or less than about 45 or equal to or less than about 40. In certain embodiments, the polymer composition, composite or article has an L* value ranging from 0 to about 65. For example, the polymer composition, composite or article may have an L* value ranging from about 5 to about 60 or from about 10 to about 55 or from about 15 to about 50 or from about 20 to about 45 or from about 25 to about 40. In certain embodiments, the composition, composite or article comprises at least about 20 wt % of graphitic material based on the total weight of the composition, composite or article. In certain embodiments, the polymer is polypropylene.

In certain embodiments, the polymer composition, composite or article retains an L* value within this range after scratching. This may be measured using the Erichsen cross-hatch method wherein specific scratch patterns are made on the surface of the polymer composition, composite or article at fixed loads (e.g. 10N). Scratch performance is then determined by measuring the difference in L* after scratching (compared with the L* value of the polymer composition, composite or article before scratching). A lower difference in L* (lower ΔL*) indicates less scratch visibility. For example, this may be measured using a 1 mm cutting tool to make 20 cuts with 2 mm between each cut, a cutting speed of 16.67 mm/s and a pressure load of 10 N.

In certain embodiments, the ΔL* of the composition, composite or article (measured as described above) is equal to or less than about 10. For example, the ΔL* of the composition, composite or article may be equal to or less than about 8 or equal to or less than about 6 or equal to or less than about 5 or equal to or less than about 4 or equal to or less than about 3 or equal to or less than about 2 or equal to or less than about 1.5 or equal to or less than about 1. For example, the ΔL* of the composition, composite or article may be at least about 0.5, for example at least about 1. In certain embodiments, the composition, composite or article comprises equal to or greater than about 20 wt % graphitic material, based on the total weight of the composition. In certain embodiments, the polymer is polypropylene.

In certain embodiments, the graphitic material disclosed herein may provide a composition consisting of polypropylene and 20 wt % of the graphitic material with an L* value equal to or less than about 65. For example, the graphitic material disclosed herein may provide a composition consisting of polypropylene and 20 wt % of the graphitic material with an L* value equal to or less than about 60 or equal to or less than about 55 or equal to or less than about 50 or equal to or less than about 45 or equal to or less than about 40. In certain embodiments, graphitic material disclosed herein may provide a composition consisting of polypropylene and 20 wt % of the graphitic material with an L* value ranging from about 0 to about 65. For example, the graphitic material disclosed herein may provide a composition consisting of polypropylene and 20 wt % of the graphitic material with an L* value ranging from about 5 to about 60 or from about 10 to about 55 or from about 15 to about 50 or from about 20 to about 45 or from about 25 to about 40.

In certain embodiments, the polymer composition, composite or article has an L* value that is at least about 10 points lower than the L* value of a corresponding composition, composite or article that does not comprise graphitic material (e.g. if the composition of the invention has an L* value of 40, the corresponding composition has an L* value of 50). For example, the polymer composition, composite or article may have an L* value that is at least about 15 points or at least about 20 points or at least about 25 points or at least about 30 points lower than the L* value of a corresponding composition, composite or article that does not comprise graphitic material. For example, the polymer composition, composite or article may have an L* value that is up to about 70 points or up to about 60 points or up to about 50 points or up to about 40 points lower than the L* value of a corresponding composition, composite or article that does not comprise graphitic material.

In certain embodiments, the polymer composition, composite or article has an L* value that is at least about 10 points lower than the L* value of a corresponding composition, composite or article that comprises an equal amount of talc in place of the graphitic material (e.g. if the composition of the invention has an L* value of 40, the corresponding composition has an L* value of 50). For example, the polymer composition, composite or article may have an L* value that is at least about 15 points or at least about 20 points or at least about 25 points or at least about 30 points lower than the L* value of a corresponding composition, composite or article that comprises an equal amount of talc in place of the graphitic material. For example, the polymer composition, composite or article may have an L* value that is up to about 70 points or up to about 60 points or up to about 50 points or up to about 40 points lower than the L* value of a corresponding composition, composite or article comprises an equal amount of talc in place of the graphitic material.

L* is determined using the CIE L*a*b* colour space. L* whiteness of the polymer composition may be measured using the spectrophotometer MINOLTA CM-3700D (illuminant)D65/10° from KONICA/MINOLTA.

In certain embodiments, the polymer compositions, composites or articles are thermally conductive. In certain embodiments, the composition, composite or article has an in-plane thermal conductivity at 25° C. equal to or greater than about 0.6 W/mk or equal to or greater than about 0.7 W/mk. In certain embodiments, the polymer composition, composite or article has an in-plane thermal conductivity at 25° C. equal to or greater than about 0.8 W/mk or equal to or greater than about 0.9 W/mk or equal to or greater than about 1 W/mk or equal to or greater than about 1.1 W/mk or equal to or greater than about 1.2 W/mk. In certain embodiments, the composition, composite or article has an in-plane thermal conductivity at 25° C. ranging from about 0.7 W/mk to about 10 W/mk or from about 0.7 W/mk to about 8 W/mk or from about 0.7 W/mk to about 6 W/mk or from about 0.7 W/mk to about 5 W/mk or from about 0.8 W/mk to about 4.5 W/mk or from about 0.9 W/mk to about 4 W/mk or from about 1 W/mk to about 3 W/mk. In certain embodiments, the composition, composite or article has an in-plane thermal conductivity of 25° C. ranging from about 0.7 W/mk to about 2 W/mk or from about 0.8 W/mk to about 1.8 W/mk or from about 0.9 W/mk to about 1.6 W/mk or from about 1 W/mk to about 1.4 W/mk. In certain embodiments, the composition, composite or article comprises equal to or greater than about 20 wt % graphitic material, based on the total weight of the composition. In certain embodiments, the polymer is polypropylene.

In certain embodiments, a graphitic material disclosed herein provides a composition consisting of polypropylene and 20 wt % of the graphitic material with an in-plane thermal conductivity at 25° C. equal to or greater than about 0.6 W/mk or equal to or greater than about 0.7 W/mk or equal to or greater than about 0.8 W/mk or equal to or greater than about 0.9 W/mk or equal to or greater than about 1 W/mk or equal to or greater than about 1.1 W/mk or equal to or greater than about 1.2 W/mk. In certain embodiments, the graphitic material provides a composition consisting of polypropylene and 20 wt % of the graphitic material with an in-plane thermal conductivity at 25° C. ranging from about 0.7 W/mk to about 10 W/mk or from about 0.7 W/mk to about 8 W/mk or from about 0.7 W/mk to about 6 W/mk or from about 0.7 W/mk to about 5 W/mk or from about 0.8 W/mk to about 4.5 W/mk or from about 0.9 W/mk to about 4 W/mk or from about 1 W/mk to about 3 W/mk. In certain embodiments, the graphitic material provides a composition consisting of polypropylene and 20 wt % of the graphitic material with an in-plane thermal conductivity of 25° C. ranging from about 0.7 W/mk to about 2 W/mk or from about 0.8 W/mk to about 1.8 W/mk or from about 0.9 W/mk to about 1.6 W/mk or from about 1 W/mk to about 1.3 W/mk.

In certain embodiments, the composition, composite or article has an in-plane thermal conductivity at 25° C. that is at least about 20% greater than the in-plane thermal conductivity at 25° C. of the corresponding composition, composite or article that does not comprise the graphitic material. For example, the composition, composite or article may have an in-plane thermal conductivity at 25° C. that is at least about 25% greater or at least about 30% greater or at least about 35% greater or at least about 40% greater or at least about 45% greater or at least about 50% greater than the in-plane thermal conductivity at 25° C. of the corresponding composition, composite or article that does not comprise the graphitic material. For example, the composition, composite or article may have an in-plane thermal conductivity at 25° C. that is up to about 100% greater or up to about 95% greater or up to about 90% greater or up to about 85% greater or up to about 80% greater or up to about 75% greater than the in-plane thermal conductivity at 25° C. of the corresponding composition, composite or article that does not comprise the graphitic material. In certain embodiments, the composition of, composite or article the invention comprises equal to or greater than about 20 wt % graphitic material, based on the total weight of the composition, composite or article.

In certain embodiments, the composition, composite or article has an in-plane thermal conductivity at 25° C. that is at least about 20% greater than the in-plane thermal conductivity at 25° C. of the corresponding composition, composite or article that does comprises an equal amount of talc in place of the graphitic material. For example, the composition, composite or article may have an in-plane thermal conductivity at 25° C. that is at least about 25% greater or at least about 30% greater or at least about 35% greater or at least about 40% greater or at least about 45% greater or at least about 50% greater than the in-plane thermal conductivity at 25° C. of the corresponding composition, composite or article that comprises an equal amount of talc in place of the graphitic material. For example, the composition, composite or article may have an in-plane thermal conductivity at 25° C. that is up to about 100% greater or up to about 95% greater or up to about 90% greater or up to about 85% greater or up to about 80% greater or up to about 75% greater than the in-plane thermal conductivity at 25° C. of the corresponding composition, composite or article that comprises an equal amount of talc in place of the graphitic material. In certain embodiments, the composition, composite or article of the invention comprises equal to or greater than about 20 wt % graphitic material, based on the total weight of the composition, composite or article.

In certain embodiments, the composition, composite or article has a through-plane thermal conductivity at 25° C. equal to or greater than about 0.2 W/mk or equal to or greater than about 0.3 W/mk. In certain embodiments, the polymer composition, composite or article has a through-plane thermal conductivity at 25° C. equal to or greater than about 0.4 W/mk or equal to or greater than about 0.5 W/mk or equal to or greater than about 0.6 W/mk or equal to or greater than about 0.7 W/mk or equal to or greater than about 0.8 W/mk or equal to or greater than about 0.9 W/mk or equal to or greater than about 1 W/mk or equal to or greater than about 1.1 W//mk or equal to or greater than about 1.2 W/mk. In certain embodiments, the composition, composite or article has a through-plane thermal conductivity at 25° C. ranging from about 0.2 W/mk to about 4 W/mk or from about 0.2 W/mk to about 2 W/mk or from about 0.2 W/mk to about 1.5 W/mk or from about 0.3 W/mk to about 1.4 W/mk or from about 0.4 W/mk to about 1.3 W/mk or from about 0.5 W/mk to about 1.2 W/mk or from about 0.6 W/mk to about 1.1 W/mk or from about 0.7 to about 1 W/mk. In certain embodiments, the composition, composite or article comprises equal to or greater than about 20 wt % graphitic material, based on the total weight of the composition. In certain embodiments, the polymer is polypropylene.

In certain embodiments, a graphitic material disclosed herein provides a composition consisting of polypropylene and 20 wt % of the graphitic material with a through-plane thermal conductivity at 25° C. equal to or greater than about 0.2 W/mk or equal to or greater than about 0.3 W/mk or equal to or greater than about 0.4 W/mk or equal to or greater than about 0.5 W/mk or equal to or greater than about 0.6 W/mk or equal to or greater than about 0.7 W/mk or equal to or greater than about 0.8 W/mk or equal to or greater than about 0.9 W/mk or equal to or greater than about 1 W/mk or equal to or greater than about 1.1 W//mk or equal to or greater than about 1.2 W/mk. In certain embodiments, the graphitic material provides a composition consisting of polypropylene and 20 wt % of the graphitic material with a through-plane thermal conductivity at 25° C. ranging from about 0.2 W/mk to about 4 W/mk or from about 0.2 W/mk to about 2 W/mk or from about 0.2 W/mk to about 1.5 W/mk or from about 0.3 W/mk to about 1.4 W/mk or from about 0.4 W/mk to about 1.3 W/mk or from about 0.5 W/mk to about 1.2 W/mk or from about 0.6 W/mk to about 1.1 W/mk or from about 0.7 to about 1 W/mk. In certain embodiments, the graphitic material provides a composition consisting of polypropylene and 20 wt % of the graphitic material with a through-plane thermal conductivity of 25° C. ranging from about 0.2 W/mk to about 1.5 W/mk or from about 0.3 W/mk to about 1.4 W/mk or from about 0.4 W/mk to about 1.3 W/mk or from about 0.5 W/mk to about 1.2 W/mk or from about 0.6 W/mk to about 1.1 W/mk or from about 0.7 to about 1 W/mk.

In certain embodiments, the composition, composite or article has a through-plane thermal conductivity at 25° C. that is at least about 20% greater than the through-plane thermal conductivity at 25° C. of the corresponding composition, composite or article that does not comprise the graphitic material. For example, the composition, composite or article may have a through-plane thermal conductivity at 25° C. that is at least about 25% greater or at least about 30% greater or at least about 35% greater or at least about 40% greater or at least about 45% greater or at least about 50% greater than the through-plane thermal conductivity at 25° C. of the corresponding composition, composite or article that does not comprise the graphitic material. For example, the composition, composite or article may have a through-plane thermal conductivity at 25° C. that is up to about 100% greater or up to about 95% greater or up to about 90% greater or up to about 85% greater or up to about 80% greater or up to about 75% greater than the through-plane thermal conductivity at 25° C. of the corresponding composition, composite or article that does not comprise the graphitic material. In certain embodiments, the composition, composite or article of the invention comprises equal to or greater than about 20 wt % graphitic material, based on the total weight of the composition, composite or article.

In certain embodiments, the composition, composite or article has a through-plane thermal conductivity at 25° C. that is at least about 20% greater than the through-plane thermal conductivity at 25° C. of the corresponding composition, composite or article that does comprises an equal amount of talc in place of the graphitic material. For example, the composition, composite or article may have a through-plane thermal conductivity at 25° C. that is at least about 25% greater or at least about 30% greater or at least about 35% greater or at least about 40% greater or at least about 45% greater or at least about 50% greater than the through-plane thermal conductivity at 25° C. of the corresponding composition, composite or article that comprises an equal amount of talc in place of the graphitic material. For example, the composition, composite or article may have a through-plane thermal conductivity at 25° C. that is up to about 100% greater or up to about 95% greater or up to about 90% greater or up to about 85% greater or up to about 80% greater or up to about 75% greater than the through-plane thermal conductivity at 25° C. of the corresponding composition, composite or article that comprises an equal amount of talc in place of the graphitic material. In certain embodiments, the composition, composite or article of the invention comprises equal to or greater than about 20 wt % graphitic material, based on the total weight of the composition, composite or article.

Thermal conductivity may be measured using a Netzsch Laserflash LFA447 according to ASTM E1461, and through-plane and in-plane thermal conductivity can be measured in accordance with the procedure described in C. Raman, High Performance Plastics 2011 Proceedings, (2011) Smithers Rapra Technology (the contents of which are incorporated herein by reference) and using compression molded samples.

In certain embodiments, the polymer composition, composite or article may be electrically conductive. In certain embodiments, the polymer composition, composite or article may be electrically conductive such that the resistivity is equal to or less than about 10⁹ Ohm/cm. For example, the polymer composition, composite or article may be electrically conductive such that the resistivity is equal to or less than about 10⁸ Ohm/cm or equal to or less than about 10⁷ Ohm/cm or equal to or less than about 10⁶ Ohm/cm or equal to or less than about 10⁵ Ohm/cm or equal to or less than about 10⁴ Ohm/cm. For example, the polymer composition, composite or article may be electrically conductive such that the resistivity is equal to or greater than about 1 Ohm/cm or equal to or greater than about 10 Ohm/cm or equal to or greater than about 100 Ohm/cm or equal to or greater than about 1000 Ohm/cm. In certain embodiments the polymer is polypropylene. In certain embodiments, the composition comprises equal to or greater than 20 wt % graphitic material.

In certain embodiments, a graphitic material disclosed herein provides a composition consisting of polypropylene and 20 wt % of the graphitic material with an electrical resistivity equal to or less than about 10⁹ Ohm/cm. For example, the graphitic material may provide a composition consisting of polypropylene and 20 wt % of the graphitic material with an electrical resistivity that is equal to or less than about 10⁸ Ohm/cm or equal to or less than about 10⁷ Ohm/cm or equal to or less than about 10⁶ Ohm/cm or equal to or less than about 10⁵ Ohm/cm or equal to or less than about 10⁴ Ohm/cm. For example, the graphitic material may provide a composition consisting of polypropylene and 20 wt % of the graphitic material with an electrical resistivity equal to or greater than about 1 Ohm/cm or equal to or greater than about 10 Ohm/cm or equal to or greater than about 100 Ohm/cm or equal to or greater than about 1000 Ohm/cm.

In certain embodiments, the composition, composite, article or resin compound when compression molded has an electrical resistivity at 25° C. that is at least about 20% less than the electrical resistivity at 25° C. of the corresponding composition, composite, article or resin compound when compression molded that does not comprise the graphitic material. For example, the composition, composite, article or resin compound when compression molded may have an an electrical resistivity at 25° C. that is at least about 25% less or at least about 30% less or at least about 35% less or at least about 40% less or at least about 45% less or at least about 50% less than the an electrical resistivity at 25° C. of the corresponding composition, composite, article or resin compound when compression molded that does not comprise the graphitic material.

For example, the composition, composite, article or resin compound when compression molded may have an electrical resistivity at 25° C. that is up to about 100% less or up to about 95% less or up to about 90% less or up to about 85% less or up to about 80% less or up to about 75% less than the an electrical resistivity at 25° C. of the corresponding composition, composite, article or resin compound when compression molded that does not comprise the graphitic material. In certain embodiments, the composition of, composite, article or resin compound when compression molded of the invention comprises equal to or greater than about 20 wt % graphitic material, based on the total weight of the composition, composite, article or resin compound when compression molded.

In certain embodiments, the composition, composite, article or resin compound when compression molded has an electrical resistivity at 25° C. that is at least about 20% less than the electrical resistivity at 25° C. of the corresponding composition, composite, article or resin compound when compression molded that does comprises an equal amount of talc in place of the graphitic material. For example, the composition, composite, article or resin compound when compression molded may have electrical resistivity at 25° C. that is at least about 25% less or at least about 30% less or at least about 35% less or at least about 40% less or at least about 45% less or at least about 50% less than the electrical resistivity at 25° C. of the corresponding composition, composite, article or resin compound when compression molded that comprises an equal amount of talc in place of the graphitic material. For example, the composition, composite, article or resin compound when compression molded may have an electrical resistivity at 25° C. that is up to about 100% less or up to about 95% less or up to about 90% less or up to about 85% less or up to about 80% less or up to about 75% less than the electrical resistivity at 25° C. of the corresponding composition, composite, article or resin compound when compression molded that comprises an equal amount of talc in place of the graphitic material. In certain embodiments, the composition, composite, article or resin compound when compression molded of the invention comprises equal to or greater than about 20 wt % graphitic material, based on the total weight of the composition, composite, article or resin compound when compression molded.

Electrical resistivity may be measured by ISO 3915 or ASTM D257 and using compression molded samples.

In certain embodiments, the polymer composition, composite or article has a density equal to or less than about 1.5 g/cm³. For example, the polymer composition, composite or article may have a density equal to or less than about 1.4 g/cm³ or equal to or less than about 1.3 g/cm³ or equal to or less than about 1.2 g/cm³ or equal to or less than about 1.1 g/cm³. For example, the polymer composition, composite or article may have a density ranging from about 0.9 g/cm³ to about 1.5 g/cm³ or from about 1 g/cm³ to about 1.4 g/cm³. In certain embodiments, the polymer is polypropylene. In certain embodiments, the composition, composite or article comprises equal to or greater than about 20 wt % graphitic material.

In certain embodiments, a graphitic material disclosed herein may provide a composition consisting of polypropylene and 20 wt % of the graphitic material with a density equal to or less than about 1.5 g/cm³. For example, the graphitic material may provide a composition consisting of polypropylene and 20 wt % of the graphitic material with a density equal to or less than about 1.4 g/cm³ or equal to or less than about 1.3 g/cm³ or equal to or less than about 1.2 g/cm³ or equal to or less than about 1.1 g/cm³. For example, the graphitic material may provide a composition consisting of polypropylene and 20 wt % of the graphitic material with a density ranging from about 0.9 g/cm³ to about 1.5 g/cm³ or from about 1 g/cm³ to about 1.4 g/cm³.

In certain embodiments, the polymer composition, composite or article may be is at least about 1% lighter than a corresponding composition, composite or article comprising an equal amount of talc in place of the graphitic material. For example, the polymer composition, composite or article may be at least about 2% or at least about 3% or at least about 4% or at least about 5% lighter than a corresponding composition, composite or article comprising an equal amount of talc in place of the graphitic material. For example, the polymer composition, composite or article may be up to about 10% or up to about 8% or up to about 6% lighter than a corresponding composition, composite or article comprising an equal amount of talc in place of the graphitic material.

In certain embodiments, the graphitic material increases the impact strength of the polymer composition, composite or article.

In certain embodiments, the polymer composition, composite or article has a Charpy impact strength (unnotched) at −20° C. that is at least about 20 kJ/m². For example, the polymer composition, composite or article may have a Charpy impact strength (unnotched) at −20° C. that is at least about 25 kJ/m² or at least about 30 kJ/m² or at least about 35 kJ/m² or at least about 40 kJ/m². For example, the polymer composition, composite or article may have a Charpy impact strength (unnotched) at −20° C. that is up to about 80 kJ/m² or up to about 70 kJ/m² or up to about 60 kJ/m² or up to about 50 kJ/m². In certain embodiments, the composition, composite or article comprises at least about 20 wt % of graphitic material based on the total weight of the composition, composite or article. In certain embodiments, the polymer is polypropylene.

In certain embodiments, a graphitic material disclosed herein may provide a composition consisting of polypropylene and 20 wt % of the graphitic material with a Charpy impact strength (unnotched) at −20° C. that is at least about 20 kJ/m² or at least about 25 kJ/m² or at least about 30 kJ/m² or at least about 35 kJ/m² or at least about 40 kJ/m². In certain embodiments, a graphitic material disclosed herein may provide a composition consisting of polypropylene and 20 wt % of the graphitic material with a Charpy impact strength (unnotched) at −20° C. that is up to about 80 kJ/m²or up to about 70 kJ/m² or up to about 60 kJ/m² or up to about 50 kJ/m².

In certain embodiments, the polymer composition, composite or article has a Charpy impact strength (unnotched or notched) at −20° C. or 23° C. that is at least about 1% greater than the Charpy impact strength (unnotched or notched) at −20° C. or 23° C. of a corresponding composition, composite or article that does not comprise graphitic material. For example, the polymer composition, composite or article may have a Charpy impact strength (unnotched or notched) at −20° C. or 23° C. that is at least about 2% greater or at least about 3% greater or at least about 4% greater or at least about 5% greater or at least about 6% greater or at least about 7% greater or at least about 8% greater or at least about 9% greater or at least about 10% greater or at least about 12% greater or at least about 14% greater or at least about 15% greater or at least about 16% greater or at least about 18% greater or at least about 20% greater than the Charpy impact strength (unnotched or notched) at −20° C. or 23° C. of a corresponding composition, composite or article that does not comprise graphitic material. For example, the polymer composition, composite or article may have a Charpy impact strength (unnotched or notched) at −20° C. or 23° C. that is up to about 100% greater or up to about 80% greater or up to about 60% greater or up to about 50% greater or up to about 40% greater or up to about 30% greater than the Charpy impact strength (unnotched or notched) at −20° C. or 23° C. of a corresponding composition, composite or article that does not comprise graphitic material. When comparing compositions, the measurement should be carried out at the same temperature and both should be notched or both should be unnotched.

In certain embodiments, the polymer composition, composite or article has a Charpy impact strength (unnotched or notched) at −20° C. or 23° C. that is within about 50% (i.e. + or −50%) of the Charpy impact strength (unnotched or notched) at −20° C. or 23° C. of a corresponding composition comprising an equal amount of talc in place of the graphitic material. In certain embodiments, the polymer composition, composite or article has a Charpy impact strength (unnotched or notched) at −20° C. or 23° C. that is within about 45% or about 40% or about 35% or about 30% or about 25% or about 20% or about 15% or about 10% or about 9% or about 8% or about 7% or about 6% or about 5% or about 4% or about 3% or about 2% or about 1% of the Charpy impact strength (unnotched or notched) at −20° C. or 23° C. of a corresponding composition comprising an equal amount of talc in place of the graphitic material. When comparing compositions, the measurement should be carried out at the same temperature and both should be notched or both should be unnotched.

In certain embodiments, the polymer composition, composite or article has a Charpy impact strength (unnotched) at 23° C. that is at least about 50 kJ/m². For example, the polymer composition, composite or article may have a Charpy impact strength (unnotched) at 23° C. that is at least about 60 kJ/m² or at least about 70 kJ/m² or at least about 80 kJ/m² or at least about 90 kJ/m² or at least about 100 kJ/m². For example, the polymer composition, composite or article may have a Charpy impact strength (unnotched) at 23° C. that is up to about 150 kJ/m² or up to about 120 kJ/m². In certain embodiments, the composition, composite or article comprises at least about 20 wt % of graphitic material based on the total weight of the composition, composite or article. In certain embodiments, the polymer is polypropylene.

In certain embodiments, a graphitic material disclosed herein may provide a composition consisting of polypropylene and 20 wt % of the graphitic material with a Charpy impact strength (unnotched) at 23° C. that is at least about 50 kJ/m² or at least about 60 kJ/m² or at least about 70 kJ/m² or at least about 80 kJ/m² or at least about 90 kJ/m² or at least about 100 kJ/m². In certain embodiments, a graphitic material disclosed herein may provide a composition consisting of polypropylene and 20 wt % of the graphitic material with a Charpy impact strength (unnotched) at 23° C. that is up to about 150 kJ/m² or up to about 120 kJ/m².

In certain embodiments, the polymer composition, composite or article has a Charpy impact strength (notched) at 23° C. that is at least about 3 kJ/m². For example, the polymer composition, composite or article may have a Charpy impact strength (notched) at 23° C. that is at least about 3.5 kJ/m² or at least about 4 kJ/m² or at least about 4.5 kJ/m². For example, the polymer composition, composite or article may have a Charpy impact strength (notched) at 23° C. that is up to about 8 kJ/m² or up to about 7 kJ/m² or up to about 6 kJ/m². In certain embodiments, the composition, composite or article comprises at least about 20 wt % of graphitic material based on the total weight of the composition, composite or article. In certain embodiments, the polymer is polypropylene.

In certain embodiments, a graphitic material disclosed herein may provide a composition consisting of polypropylene and 20 wt % of the graphitic material with a Charpy impact strength (notched) at 23° C. that is at least about 3 kJ/m² or at least about 3.5 kJ/m² or at least about 4 kJ/m² or at least about 4.5 kJ/m². In certain embodiments, a graphitic material disclosed herein may provide a composition consisting of polypropylene and 20 wt % of the graphitic material with a Charpy impact strength (notched) at 23° C. that is up to about 8 kJ/m² or up to about 7 kJ/m² or up to about 6 kJ/m².

Charpy impact strength is measured on notched or unnotched 80 mm by 10 mm by 4 mm bars according to ISO 179.

In certain embodiments, the graphitic material increases the stiffness of the polymer composition, composite or article.

In certain embodiments, the polymer composition, composite or article has a flexural modulus equal to or greater than about 1800 MPa. For example, the polymer composition, composite or article may have a flexural modulus equal to or greater than about 1900 MPa or equal to or greater than about 2000 MPa or equal to or greater than about 2100 MPa or equal to or greater than about 2200 MPa or equal to or greater than about 2300 MPa or equal to or greater than about 2400 MPa. For example, the polymer composition, composite or article may have a flexural modulus up to about 3000 MPa, for example up to about 2900 MPa or up to about 2800 MPa or up to about 2700 MPa or up to about 2600 MPa or up to about 2500 MPa. In certain embodiments, the polymer is polypropylene. In certain embodiments, the composition, composite or article comprises at least about 20 wt % graphitic material based on the total weight of the polymer composition, composite or article.

In certain embodiments, the graphitic material provides a composition consisting of polypropylene and 20 wt % of the graphitic material with a flexural modulus equal to or greater than about 1800 MPa or equal to or greater than about 1900 MPa or equal to or greater than about 2000 MPa or equal to or greater than about 2100 MPa or equal to or greater than about 2200 MPa or equal to or greater than about 2300 MPa or equal to or greater than about 2400 MPa. In certain embodiments, the graphitic material provides a composition consisting of polypropylene and 20 wt % of the graphitic material with a flexural modulus up to about 3000 MPa, for example up to about 2900 MPa or up to about 2800 MPa or up to about 2700 MPa or up to about 2600 MPa or up to about 2500 MPa.

In certain embodiments, the polymer composition, composite or article has a flexural modulus that is at least about 1% greater than the flexural modulus of a corresponding composition, composite or article that does not comprise graphitic material. For example, the polymer composition, composite or article may have a flexural modulus that is at least about 5% greater or at least about 10% greater or at least about 15% greater or at least about 20% greater or at least about 25% greater or at least about 30% greater than the flexural modulus of a corresponding composition, composite or article that does not comprise graphitic material. For example, the polymer composition, composite or article may have a flexural modulus that is up to about 100% greater or up to about 90% greater or up to about 80% greater or up to about 70% greater or up to about 60% greater or up to about 50% greater than the flexural modulus of a corresponding composition, composite or article that does not comprise graphitic material.

In certain embodiments, the polymeric composition, composite or article has a flexural modulus that is within about 20% (+ or −20%) of the flexural modulus of a corresponding composition, composite or article that comprises an equal amount of talc in place of the graphitic material. For example, the polymeric composition, composite or article may have a flexural modulus that is within about 15% or about 10% or about 9% or about 8% or about 7% or about 6% or about 5% or about 4% or about 3% or about 2% or about 1% of the flexural modulus of a corresponding composition, composite or article that comprises an equal amount of talc in place of the graphitic material.

Flexural modulus is measured on 80 mm by 10 mm by 4 mm bars according to ISO 178.

In certain embodiments, the composition, composite or article has a heat deformation temperature (HDT) that is equal to or greater than about 45° C. In certain embodiments, the composition, composite or article has a HDT equal to or greater than about 46° C. or equal to or greater than about 47° C. or equal to or greater than about 48° C. or equal to or greater than about 49° C. or equal to or greater than about 50° C. For example, the composition, composite or article may have a HDT up to about 65° C. or up to about 60° C. or up to about 59° C. or up to about 58° C. or up to about 57° C. or up to about 56° C. or up to about 55° C. In certain embodiments, the polymer is polypropylene. In certain embodiments, the composition, composite or article comprises equal to or greater than about 20 wt % graphitic material based on the total weight of the composition, composite or article.

In certain embodiments, the graphitic material provides a composition consisting of polypropylene and 20 wt % of the graphitic material with a HDT that is equal to or greater than about 45° C. or equal to or greater than about 46° C. or equal to or greater than about 47° C. or equal to or greater than about 48° C. or equal to or greater than about 49° C. or equal to or greater than about 50° C. In certain embodiments, the graphitic material provides a composition consisting of polypropylene and 20 wt % of the graphitic material with a HDT that is up to about 65° C. or up to about 60° C. or up to about 59° C. or up to about 58° C. or up to about 57° C. or up to about 56° C. or up to about 55° C.

In certain embodiments, the composition, composite or article has a HDT that is within about 10° C. (+ or −10° C.) of the HDT of a corresponding composition comprising an equal amount of talc in place of the graphitic material. For example, the composition, composite or article may have a HDT that is within about 9° C. or about 8° C. or about 7° C. or about 6° C. or about 5° C. or about 4° C. or about 3° C. of the HDT of a corresponding composition comprising an equal amount of talc in place of the graphitic material.

HDT may be measured on 80 mm by 10 mm by 4 mm bars according to ISO 75A.

In certain embodiments, the graphitic material decreases the coefficient of linear thermal expansion (CLTE) of the polymer composition, composite or article.

In certain embodiments, the polymer composition, composite or article has a CLTE equal to or less than about 160×10⁻⁶° C. For example, the polymer composition, composite or article may have a CLTE equal to or less than about 155×10⁻⁶° C. or equal to or less than about 150×10⁻⁶° C. or equal to or less than about 145×10⁻⁶° C. or equal to or less than about 140×10⁻⁶° C. For example, the polymer composition, composite or article may have a CLTE equal to or greater than about 50×10⁻⁶° C. or equal to or greater than about 60×10⁻⁶° C. or equal to or greater than about 70×10⁻⁶° C. or equal to or greater than about 80×10⁻⁶° C. or equal to or greater than about 90×10⁻⁶° C. or equal to or greater than about 100×10⁻⁶° C. In certain embodiments the polymer is polypropylene. In certain embodiments, the composition, composite or article comprises at least about 20 wt % of graphitic material, based on the total weight of the composition, composite or article.

In certain embodiments, the graphitic material provides a composition consisting of polypropylene and 20 wt % of the graphitic material with a CLTE that is equal to or less than about 160×10⁻⁶° C. or equal to or less than about 155×10⁻⁶° C. or equal to or less than about 150×10⁻⁶° C. or equal to or less than about 145×10⁻⁶° C. or equal to or less than about 140×10⁻⁶° C. In certain embodiments, the graphitic material provides a composition consisting of polypropylene and 20 wt % of the graphitic material with a CLTE that is equal to or greater than about 50×10⁻⁶° C. or equal to or greater than about 60×10⁻⁶° C. or equal to or greater than about 70×10⁻⁶° C. or equal to or greater than about 80×10⁻⁶° C. or equal to or greater than about 90×10⁻⁶° C. or equal to or greater than about 100×10⁻⁶° C.

In certain embodiments, the polymer composition, composite or article has a CLTE that is at least about 1% less than the CLTE of a corresponding composition that does not comprise graphitic material. In certain embodiments, the polymer composition, composite or article has a CLTE that is at least about 2% or at least about 3% or at least about 4% or at least about 5% or at least about 10% or at least about 15% or at least about 20% or at least about 25% or at least about 30% less than the CLTE of a corresponding composition that does not comprise graphitic material. In certain embodiments, the polymer composition, composite or article has a CLTE that is up to about 80% less or up to about 70% less or up to about 60% less or up to about 50% less than the CLTE of a corresponding composition that does not comprise graphitic material.

In certain embodiments, the polymer composition, composite or article has a CLTE that is within about 40% (+ or −40%) of the CLTE of a corresponding composition comprising an equal amount of talc in place of the graphitic material. In certain embodiments, the polymer composition, composite or article has a CLTE that is within about 35% or within about 30% or within about 25% or within about 20% or within about 15% or within about 10% or within about 5% of the CLTE of a corresponding composition comprising an equal amount of talc in place of the graphitic material.

CLTE may be measured simultaneously on two injected plaques of 2 mm thickness that are die-cut to obtain 50 mm by 50 mm by 2 mm dimensions in a ventilated and temperature controlled oven. CLTE is recorded using LVDT sensors following annealing at 80° C. for 4 hours. It is then measured during the second stage of the temperature programme (temperature starts at 23° C. and is increased at a rate of 1° C. per minute up to 70° C.), by measuring evolution of dimensions through captors on the plastic specimen. This is measured both parallel and perpendicular to the polymer flow and an average value is calculated.

In certain embodiments, the graphitic material increases the UV stability of the polymer composition, composite or article. Without wishing to be bound by theory, it is believed that this is because the graphitic material absorbs the UV light and/or reflects the UV light, and thus makes it less likely to degrade the polymer matrix. This is advantageous since UV exposure may induce polymer degradation and may, for example, adversely affect the colour, shape and/or mechanical properties (e.g. tensile strength) of the materials used.

The effect of UV may be determined in accordance with any suitable method by comparing the effect of UV on a composition before and after addition of the graphitic material. In certain embodiments, the improvement in UV stability may be determined by accelerated weathering. This involves the simulation of environmental conditions using special chambers and instruments to speed up the weathering process. For example, one of the following testing standards may be used: ASTM D4587, ASTM D4329, ISO 4892, SAE J2020, SAE J2527 and SAE J2412.

A “corresponding composition” referred to herein is a composition that is identical to the composition to which it is being compared, except that it does not comprise any graphitic material, and optionally comprises an equal amount of talc in place of the graphitic material.

Methods of Making the Polymer Compositions, Composites and Articles

The composition of the present invention can be prepared by combining (e.g. mixing) the components thereof intimately together in any suitable order. For example, the polymer and any other components of the composition may be combined first and then the graphitic material or the inorganic particulate material may be combined (e.g. blended, e.g., dry blended) with the first composition. The composition may be processed to form a final polymer composite or article.

Preparation of the compositions of the present invention can be accomplished by any suitable mixing method known in the art, as will be readily apparent to one of ordinary skill in the art.

Such methods include dry blending of the individual components or precursors thereof and subsequent processing in a conventional manner. Certain of the ingredients can, if desired, be pre-mixed before addition to the compounding mixture.

In the case of thermoplastic polymer compositions, such processing may comprise melt mixing, either directly in an extruder for making an article from the composition, or pre-mixing in a separate mixing apparatus. Dry blends of the individual components can alternatively be directly injection moulded without pre-melt mixing.

The composition can be prepared by mixing of the components thereof intimately together. The graphitic material may then be suitably dry blended with the polymer and any desired additional components, before processing as described above.

Other filler compounds, may be added and blended in at the mixing stage.

For the preparation of cross-linked or cured polymer compositions, the blend of uncured components or their precursors, and, if desired, the graphitic material and any desired non-graphitic component(s), will be contacted under suitable conditions of heat, pressure and/or light with an effective amount of any suitable cross-linking agent or curing system, according to the nature and amount of the polymer used, in order to cross-link and/or cure the polymer.

For the preparation of polymer compositions where the graphitic material and any desired other component(s) are present in situ at the time of polymerisation, the blend of monomer(s) and any desired other polymer precursors, graphitic material and any other component(s) will be contacted under suitable conditions of heat, pressure and/or light, according to the nature and amount of the monomer(s) used, in order to polymerise the monomer(s) with the graphitic material and any other component(s) in situ.

In certain embodiments, the graphitic material is dispersed with agitation into a mixture comprising polymer (for example, polypropylene) and optionally a curing agent. The mixture may further comprise a mould release agent.

The resulting dispersion can be degassed to remove entrained air. The resulting dispersion can then be poured into a suitable mould and cured. Suitable curing temperatures range from 20-200° C., for example 20-120° C., or, for example, 60-90° C.

The starting polymer mixture can further comprise a pre-polymer (for example, propylene monomer). The pre-polymer may or may not correspond to the starting polymer.

The viscosity of the starting polymer or polymer/monomer solution, amount of curing agent, release agent and inorganic particulate material can be varied according to the requirements of the final cured product. Generally, the greater the amount of inorganic particulate material added, the higher the viscosity of the dispersion. Dispersant agents can be added to reduce the viscosity of the dispersion. Alternatively, the amount of polymer in the starting solution can be reduced.

Suitable curing agents will be readily apparent to one of ordinary skill in the art, and include organic peroxides, hydroperoxides and azo compounds. Examples of peroxide and hydroperoxide curing agents include dimethyl dibutylperoxyhexane, benzyl peroxide, dicumyl peroxide, methyl ethyl ketone peroxide, lauryl peroxide, cyclohexanone peroxide, t-butyl perbenzoate, t-butyl hydroperoxide, t-butyl benzene hydroperoxide, cumene hydroperoxide and t-butyl peroctoate.

The compounded compositions may further comprise additional components, such as slip aids (for example Erucamide), process aids (for example Polybatch® AMF-705), mould release agents and antioxidants.

Suitable mould release agents will be readily apparent to one of ordinary skill in the art, and include fatty acids, and zinc, calcium, magnesium and lithium salts of fatty acids and organic phosphate esters. Specific examples are stearic acid, zinc stearate, calcium stearate, magnesium stearate, lithium stearate calcium oleate, zinc palmitate. Typically, slip and process aids, and mould release agents are added in an amount less than about 5 wt. % based on the weight of the masterbatch. Polymer articles, including those described above, may then be extruded, compression moulded or injected moulded using conventional techniques known in the art, as will be readily apparent to one of ordinary skill in the art. Thus, as described below, the present invention is also directed to articles formed from the compositions of the present invention.

In certain embodiments, the polymer composition comprises a colorant which, if present, will be added during compound of the polymer composition. The colorant may be added in the form of a masterbatch. Suitable colours are many and various.

In certain embodiments, graphitic material is added to a twin-screw extruder to which unfilled polymer is being fed and made molten. The graphitic material is fed into the extruder through a hopper, for example, via gravimetric feeding, and uniformly blends with the polymer. The mixture emerges from the extruder and may be cooled. Then, for example, the mixture can be further compression moulded or injection moulded into useful shapes.

The methods described above may include compounding and extrusion. Compounding may be carried out using a twin screw compounder, for example, a Clextral BC 21 double screw extruder or a Leistritz ZSE 18 double screw extruder or Baker Perkins 25 mm twin screw compounder. The polymer, graphitic material and optional additional components may be premixed and fed from a single hopper. The resulting melt may be cooled, for example, in a water bath, and then pelletized. Test pieces, e.g., charpy bars or tensile dumbbells, may be injection moulded or cast or blown into film.

The screw temperature may be between about 100° C. and about 300° C., for example, between about 150° C. and about 280° C., for example, between about 180° C. and about 250° C., or between about 200 and 230° C.

Screw speed may be between about 100 and 1200 rpm, for example, between about 100 and 1000 rpm, for example, between about 200 and 800 rpm, for example, between about 250 and 650 rpm, for example, between about 200 and 400 rpm, or between about 500 and 700 rpm. In certain embodiments, screw speed is about 300 rpm. In other embodiments, screw speed is about 600 rpm.

Suitable injection molding apparatus includes, for example, a Billion 50T Proxima press. The polymer composition may be dried prior to molding. Drying may be carried out at any suitable temperature, for example, about 60° C., for a suitable period of time, for example, between about 1 hours and 20 hours, for example, between about 2 and 18 hours, or between about 1 and 3 hours, or between about 4 and 8 hours, or between about 12 and 18 hours. The temperature during drying may be kept constant or varied. In certain embodiments, the temperature during drying is between about 70 and 120° C., for example, between about 80 and 100° C., for example, about 90° C.

Molding is generally conducted at a temperature at which the polymer composition is flowable. For example, the molding temperature may be between about 100 and 300° C., for example, between about 200 and 300° C., or between about 240 and about 280° C. Following molding the molded piece will be allowed to cool and set.

Other suitable processing techniques include gas-assisted injection molding, calendaring, vacuum forming, thermoforming, blow-molding, drawing, spinning, film forming, laminating or any combination thereof. Any suitable apparatus may be used, as will be apparent to one of ordinary skill in the art.

The polymer composition can be processed to form, or to be incorporated in, articles of commerce in any suitable way, as described herein. The articles which may be formed from the polymer composition are many and various. Examples include automotive body parts and panels, for example, a bonnet (hood), wing piece, wing-mirror casing, door (front and/or rear), tail gate and bumper (front and/or rear).

The following numbered paragraphs may also define particular embodiments of the present invention:
1. A composition comprising:
   a polymer; and
   equal to or greater than about 1 wt % of a graphitic material;
   wherein the composition has a L* value equal to or less than about 65.
2.The composition of paragraph 1, wherein the polymer is a polyolefin such as polypropylene.
3.The composition of paragraph 1 or 2, wherein the graphitic material is natural graphite, synthetic graphite, expanded graphite, exfoliated graphite, graphene, few-layer graphene, graphite fibers, nano-graphite, graphitized fine coke, or mixtures thereof.
4.The composition of any one of paragraphs 1 to 3, wherein the composition comprises from about 1 wt % to about 70 wt % of the graphitic material, for example from about 5 wt % to about 30 wt % of the graphitic material.
5.The composition of any one of paragraphs 1 to 4, wherein the composition further comprises another inorganic particulate material such as talc and/or carbon black.
6.The composition of any one of paragraphs 1 to 5, wherein the composition further comprises from about 5 wt % to about 70 wt %, for example from about 5 wt % to about 40 wt % talc.
7.The composition of paragraph 5 or 6, wherein the weight ratio of talc to graphitic material ranges from about 20:1 to about 1:20.
8. The composition of any one of paragraphs 1 to 7, wherein the composition further comprises from about 1 wt % to about 10 wt % carbon black.
9.The composition of paragraph 5 or 8, wherein the weight ratio of carbon black to graphitic material ranges from about 5:1 to about 1:50.
10. The composition of any one of paragraphs 1 to 9, wherein the composition comprises up to about 80 wt % total inorganic particulate material.
11. The composition of any one of paragraphs 1 to 10, wherein the composition comprises at least about 20 wt % polymer, for example at least about 30 wt % polymer.
12. The composition of any one of paragraphs 1 to 11, wherein the composition has a L* value equal to or less than about 60 or equal to or less than about 45.
13. The composition of any one of paragraphs 1 to 12, wherein the graphitic material is a natural graphite or synthetic graphite.
14. The composition of any one of paragraphs 1 to 13, wherein the graphitic material has a d₅₀ ranging from about 1 μm to about 20 μm.
15. The composition of any one of paragraphs 1 to 14, wherein the graphitic material has a d₉₀ ranging from about 2 μm to about 50 μm.
16. The composition of any one of paragraphs 1 to 15, wherein the graphitic material has a d₅₀ ranging from about 1 μm to about 5 μm or from about 15 μm to about 19 μm.
17. The composition of any one of paragraphs 1 to 16, wherein the polymer is polypropylene and the composition has a Charpy impact strength at −20° C. equal to or greater than about 20 kJ/m².
18. The composition of any one of paragraphs 1 to 17, wherein the polymer is polypropylene and the composition has a heat deflection temperature equal to or greater than about 45° C.
19. The composition of any one of paragraphs 1 to 18, wherein the polymer is polypropylene and the composition has a coefficient of linear thermal expansion (CLTE) equal to or less than about 150×10⁻⁶° C.
20. The composition of any one of paragraphs 1 to 19, wherein the composition has a thermal conductivity at 25° C. equal to or greater than about 0.6 W/mk.
21. The composition of any one of paragraphs 1 to 20, wherein the composition is electrically conductive such that the resistivity is less than 10⁹ Ohm/cm.
22. A polymer composite or article formed from, for example extruded or molded from, a composition of any one of paragraphs 1 to 21.
23. The polymer composite or article of paragraph 22, wherein the polymer composite or article is an automotive body part.
24. A method for making a composition according to any one of paragraphs 1 to 21, the method comprising combining the polymer with the graphitic material and any optional components.
25. The method of paragraph 23, further comprising extruding or molding the composition of any one of paragraphs 1 to 21.
26. Use of a composition of any one of paragraphs 1 to 21 or a polymer composite or article of paragraph 22 to make an automotive body part.
27. Use of at least about 1 wt % of a graphitic material as a filler in a polymer composition to replace at least a portion to another inorganic mineral filler and/or to provide at least one of the following properties as compared to the polymer composition that is devoid of the at least about 1 wt % graphitic material:
   a. higher impact resistance;
   b. higher tensile strength
   c. higher stiffness;
   d. lower L* value (e.g. after scratching);
   e. higher thermal conductivity;
   f. reduced cycling time during processing;
   g. higher electrical conductivity;
   h. increased UV stability
   i. decreased weight; and
   j. decreased density.

The invention will now be described in detail by way of reference only to the following non-liming examples.

### EXAMPLES

### Example 1

Compositions comprising polypropylene copolymer (grade 7075L from Exxon Mobil) and 20 wt % of graphitic material were compared to compositions comprising the same polypropylene copolymer and 20 wt % talc.

The Following Graphitic Materials were used:
Graphite A (synthetic graphite having a d₅₀ of 18 μm and a d₉₀ of 42 μm as measured by laser diffraction);
Graphite B (natural graphite having a d₅₀ of 17 μm and a d₉₀ of 39 μm as measured by laser diffraction);
Graphite C (natural graphite having a d₅₀ of 6 μm and a d₉₀ of 12 μm as measured by laser diffraction).

The Following Talc Materials were used:
Talc A (talc having a d₅₀ of 6 μm and a d₉₅ of 13.1 μm as measured by laser diffraction);
Talc B (talc having a d₅₀ of 11.4 μm and a d₉₅ of 13.2 μm as measured by laser diffraction).

The unnotched Charpy impact resistance at −20° C., unnotched Charpy impact resistance at 23° C., notched Charpy impact resistance at 23° C., flexural modulus, HDT, CLTE and L*, were measured using the methods described above using injection molded samples. In-plane and through-plane thermal conductivity at 25° C., density and electrical resistivity were measured using the methods described above using compression molded samples.

The results of the HDT, CLTE, L*, density and thermal conductivity measurements are shown in Table 1.

The results of the L*, Charpy impact resistance and flexural modulus measurements are shown in Table 2.

TABLE 1

| | | | | Thermal | Thermal | |
|---|---|---|---|---|---|---|
| | | | | Conductivity | Conductivity | |
| | HDT | CLTE | Density | (in-plane) | (through-plane) | Resistivity |
| Composition | (° C.) | (×10⁻⁶ ° C.) | (g/cm³) | (W/mk) | (W/mk) | (Ohm · cm) |
| Polypropylene (PP) | 50.5 | 162 | 0.89 | — | — | — |
| copolymer | | | | | | |
| PP + 20 wt % | 50 | 113 | 1.02 | — | — | — |
| Graphite A, produced | | | | | | |
| from a masterbatch | | | | | | |
| including 40 wt % | | | | | | |
| Graphite A | | | | | | |
| PP + 20 wt % | 51 | 112 | 1.02 | 1.2 | 0.9 | 9.29E+7 |
| Graphite B | | | | | | |
| PP + 20 wt % | 50.4 | 113 | 1.02 | 1.0 | 0.8 | 4.63E+4 |
| Graphite C | | | | | | |
| PP + 20 wt % | 53 | 109 | 1.04 | 0.6 | 0.4 | >1E+11 |
| Talc A | | | | | | |
| PP + 20 wt % | 57.5 | 87 | 1.04 | 0.7 | 0.5 | >1E+11 |
| Talc B | | | | | | |

TABLE 2

| | | Unnotched | | Notched | Unnotched |
|---|---|---|---|---|---|
| | | Charpy | | Charpy | Charpy |
| | | impact | | impact | impact |
| | | resistance | Flexural | resistance | resistance |
| | | at −20° C. | modulus | at 23° C. | at 23° C. |
| Composition | L* | (kJ/m²) | (MPa) | (kJ/m²) | (kJ/m²) |
| Polypropylene | 81.8 | — | 1023 | — | — |
| (PP) | | | | | |
| copolymer | | | | | |
| PP + 20 wt % | 39.2 | 29 | 2184 | — | — |
| Graphite A | | | | | |
| PP + 20 wt % | 39.9 | 32 | 2221 | 3.7 | 60 |
| Graphite B | | | | | |
| PP + 20 wt % | 39.1 | 41 | 2343 | 4.8 | 130 |
| Graphite C | | | | | |
| PP + 20 wt % | 70.8 | 27 | 2645 | 5.3 | 190 |
| Talc A | | | | | |
| PP + 20 wt % | 66 | 54 | 2153 | 5.1 | 75 |
| Talc B | | | | | |

It was surprisingly found that the graphitic materials provided polymer compositions with similar impact strength, HDT, CLTE and density to compositions comprising the same amount of talc. It was further surprisingly found that the graphitic materials provided polymer compositions that are black in colour and had increased thermal conductivity.

### Example 2

The colour of compositions comprising polypropylene copolymer (grade 7075L from Exxon Mobil) and various amounts of graphitic material (Graphite B or Graphite C as in Example 1 above), talc and/or carbon black were compared to compositions not comprising carbon black.

Various colour parameters of the compositions were measured by the method described above.

The results are shown in Table 3.

TABLE 3

| Composition | L* | a* | b* |
|---|---|---|---|
| 20 wt % Graphite B | 39.9 | 0.61 | 0.92 |
| 20 wt % Graphite B + 0.17 wt % carbon black | 35.5 | 0.48 | 0.56 |
| 20 wt % Graphite B + 0.33 wt % carbon black | 35.6 | 0.51 | 0.64 |
| 20 wt % Graphite B + 0.67 wt % carbon black | 35.4 | 0.51 | 0.61 |
| 20 wt % Graphite B + 1 wt % carbon black | 34 | 0.49 | 0.52 |
| 20 wt % Graphite B + 1.67 wt % carbon black | 32.8 | 0.45 | 0.35 |
| 20 wt % Graphite B + 3.33 wt % carbon black | 31.4 | 0.38 | 0.04 |
| 20 wt % Graphite B + 5 wt % carbon black | 29.9 | 0.31 | −0.26 |
| 20 wt % Graphite C + 1.67 wt % carbon black | 31.6 | 0.37 | 0.18 |
| 20 wt % Talc A + 1 wt % carbon black | 25.5 | 0.06 | −0.12 |
| 20 wt % Graphite C | 39.1 | 0.57 | 0.81 |

1. A composition comprising:
a polymer; and
equal to or greater than about 1 wt % of a graphitic material;
wherein the composition has a L* value equal to or less than about 65.

2. The composition of claim 1, wherein the polymer is a polyolefin such as polypropylene.

3. The composition of claim 1, wherein the graphitic material is natural graphite, synthetic graphite, expanded graphite, exfoliated graphite, graphene, few-layer graphene, graphite fibers, nano-graphite, graphitized fine coke, or mixtures thereof.

4. The composition of claim 1 any one of claims 1 to 3, wherein the composition comprises from about 1 wt % to about 70 wt % of the graphitic material for example from about 5 [symbol] A % to about 30 [symbol] 1A % of the graphitic material.

5. The composition of claim 1 any one of claims 1 to 4. wherein the composition further comprises talc, carbon blank, or another inorganic particulate material such as talc and/or carbon black.

6. The composition of claim 1 any one of claims 1 to 5, wherein the composition further comprises from about 5 wt % to about 70 wt %, for example from about 5 \″It % to about 40 [symbol] v-t % talc.

7. The composition of claim §-ef 6, wherein the weight ratio of talc to graphitic material ranges from about 20:1 to about 1:20.

8. The composition of claim 1 any one of claims 1 to 7, wherein the composition further comprises from about 1 wt % to about 10 wt % carbon black.

9. The composition of claim 8 claim 5 or 8, wherein the weight ratio of carbon black to graphitic material ranges from about 5:1 to about 1:50.

10. The composition of claim 9 any one of claims 1 to 9, wherein the composition comprises up to about 80 wt % total inorganic particulate material.

11. The composition of claim 1 any one of claims 1 to 10, wherein the composition comprises at least about 20 wt % polymer, f.or example at least about 30 wt % polymer.

12. The composition of claim 1 any one of claims 1 to 11, wherein the graphitic material has a dso ranging from about 1 μm to about 20 μm andtor or a dgo ranging from about 2 μm to about 50 μm.

13. A polymer composite or article extruded molded, or otherwise formed from for example extruded or molded from a composition of claim 1-aRy one of claims 1 to 12.

14. A method for making a composition according to claim 1 aAy one of claims 1 to 12, the method comprising combining the polymer with the graphitic material and any optional components.

15. A method comprising: adding Use of at least about 1 wt % of a graphitic material as a filler in a polymer composition to replace at least a portion to another inorganic mineral filler, wherein the polymer composition exhibits and/oF-to provide at least one of the following properties as compared to the polymer composition that is devoid of the at least about 1 wt % graphitic material:
a. higher impact resistance;
b. higher tensile strength
c. higher stiffness;
d. lower L* value (e.g. after scratching);
e. higher thermal conductivity;
f. reduced cycling time during processing;
g. higher electrical conductivity;
h. increased UV stability
i. decreased weight; and
j. decreased density.

16. The composition of claim 1, wherein
the composition further comprises talc; and
the composition comprises from about 1 wt % to about 70 wt % of the graphitic material and from about 5 wt % to about 70 wt % talc.

17. The composition of claim 16, wherein the weight ratio of talc to graphitic material ranges from about 20:1 to about 1:20.

18. The composition of claim 16, wherein
the composition further comprises carbon black; and
the composition comprises from about 1 wt % to about 10 wt % of the carbon black.

19. The composition of claim 18, wherein the weight ratio of carbon black to graphitic material ranges from about 5:1 to about 1:50.

20. The composition of claim 19, wherein the composition comprises up to about 80 wt % total inorganic particulate material.
